(19) United States
(12) Patent Application Publication
(10) Pub. No.: US 2022/0397000 A1
(43) Pub. Date: Dec. 15, 2022

(54) Safety Ladder Device

(71) Applicant: Carol Oxford, Las Cruces, NM (US)

(72) Inventor: Carol Oxford, Las Cruces, NM (US)

(21) Appl. No.: 17/691,224

(22) Filed: Mar. 10, 2022

Related U.S. Application Data
(60) Provisional application No. 63/208,680, filed on Jun. 9, 2021.

(51) Int. Cl. E06C 1/20; E06C 1/18; E06C 1/383; E06C 7/18

(52) U.S. Cl. CPC E06C 1/20; E06C 1/18; E06C 1/383; E06C 7/185

(57) ABSTRACT

The present invention relates to a safety ladder device primarily comprised of a ladder frame, a plurality of ladder feet, a first outrigger, a second outrigger and at least one safety strap. The plurality of ladder feet may further be comprised of a continuous opening that can receive a ground spike or fastener that allows a user to secure the device to and/or into a nearby surface for stabilization of the device during use. Both outriggers preferably attach to each side of the top step of the ladder frame via a hinge that allows both outriggers to move freely and be placed at a variety of angles to further stabilize the device. In addition, the at least one safety strap is positioned around the device, such that it prevents a user from falling off the device, yet still allows the device to remain fully functional.

### CROSS-REFERENCE TO RELATED APPLICATION

The present application claims priority to, and the benefit of, U.S. Provisional Application No. 63/208,680, which was filed on Jun. 9, 2021 and is incorporated herein by reference in its entirety.

### FIELD OF THE INVENTION

The present invention relates generally to the field of ladders. More specifically, the present invention relates to a safety ladder device primarily comprised of a ladder frame, a plurality of ladder feet, a first outrigger, a second outrigger and at least one safety strap. The plurality of ladder feet may further be comprised of a continuous opening that can receive a ground spike or fastener, which allows a user to secure the device to and/or into a nearby surface for stabilization during use. Both outriggers preferably attach to each side of the top step of the ladder frame via a hinge that allows both outriggers to move freely. Thus, the outriggers can be positioned in a variety of angles to further stabilize the device. In addition, the at least one safety strap is positioned around the device such that it prevents a user from falling off the device, yet still allows the device to remain fully climbable. Accordingly, the present disclosure makes specific reference thereto. Nonetheless, it is to be appreciated that aspects of the present invention are also equally applicable to other like applications, devices and methods of manufacture.

### BACKGROUND

Ladders are regularly used to reach high places while cleaning, building and performing other tasks. However, ladders can be dangerous, as each year there are more than 164,000 emergency room-treated injuries and 300 deaths in the U.S. caused by falls from ladders, with most ladder deaths coming from falls of 10 feet or less. In addition, falls from ladders are the leading cause of death on construction sites. Further, individuals may fall off ladders due to their inexperience or the instability of the ladder itself.

Therefore, there exists a long-felt need in the art for an improved ladder. There also exists a long-felt need in the art for an improved ladder that provides stabilization when in use. In addition, there exists a long-felt need in the art for a safety ladder device that comprises safety mechanisms to prevent a user from falling off the device. Finally, there exists a long-felt felt need in the art for a safety ladder device that comprises safety mechanisms to prevent the death and serious injury of a user.

The subject matter disclosed and claimed herein, in one embodiment thereof, comprises a safety ladder device. The device is primarily comprised of a ladder frame, a plurality of ladder feet, a first outrigger, a second outrigger and at least one safety strap. The plurality of ladder feet may further be comprised of a continuous opening that can receive a ground spike or fastener that allows a user to secure the device to and/or into a nearby surface for stabilization of the device during use. Both outriggers preferably attach to each side of the top step of the ladder frame via a hinge that allows both outriggers to move freely. Thus, the outriggers can be positioned in a variety of angles to further stabilize the ladder device. Each outrigger may also have a foot that has a continuous opening that can receive a ground spike or fastener, which allows a user to secure the device to and/or into a nearby surface for stabilization of the device during use. In addition, the at least one safety strap is positioned around the ladder device such that it prevents a user from falling off the device, yet still allows the device to remain fully functional and climbable.

In this manner, the safety ladder device of the present invention accomplishes all of the forgoing objectives and provides an improved ladder that is safer and more stable than existing ladders known in the art. The outriggers of the device provide more stabilization to the ladder frame and the safety strap prevents a user from falling off the device, while still allowing a user to use the device in an unobstructed manner. Therefore, both the outriggers and the safety strap serve as safety mechanisms to prevent the death and serious injury of a user while using the device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a safety ladder device that is primarily comprised of a ladder frame, a plurality of ladder feet, a first outrigger, a second outrigger and at least one safety strap. Each of the plurality of ladder feet may further be comprised of a continuous opening that can receive a ground spike or fastener that allows a user to secure the device to and/or into a nearby surface for stabilization of the device during use. Both outriggers preferably attach to each side of the top step of the ladder frame via a hinge that allows both outriggers to move freely. In this manner, the outriggers can be positioned in a variety of angles to further stabilize the device. Each outrigger may also have a foot that has a continuous opening that can receive a ground spike or fastener, which allows a user to secure the device to and/or into a nearby surface for stabilization of the device during use. In other embodiments, the outriggers may be of a fixed length or may be telescopic (i.e. adjustable length).

The device is further comprised of at least one safety strap. The strap is positioned around the ladder frame such that it does not obstruct a user's ability to climb the device, but still prevents a user from falling backwards off the device. Each safety strap is further comprised of an end piece that has a first vertical sidewall, a second vertical sidewall, an outside wall, a hinge and a lock. Each end piece engages the front surface and rear surface of the ladder frame to inhibit forward and/or backward movement of the strap. To further secure the strap to the ladder frame, a horizontal cross member is connected to either the first sidewall or the second sidewall via at least one hinge, wherein the hinge allows the cross member to open such that the end piece can be positioned around the front surface, rear surface and outside side surface of the ladder frame. Once positioned around the frame, the cross member can be closed via the hinge and locked via a lock that attaches to the first or second sidewall. As a result, the strap becomes immovable and cannot be removed from the device, even if a user falls and his or her weight contacts the strap.

Accordingly, the improved safety ladder device of the present invention is particularly advantageous as it provides a safer and more stable ladder-type device. Further, the outriggers of the device provide increased stabilization to the device. In addition, the safety strap prevents a user from falling off the device, while still allowing a user to use the device in an unobstructed manner. Therefore, both the outriggers and the safety strap serve as safety mechanisms to prevent the death and serious injury of a user while using the device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the safety ladder device of the present invention wherein both outriggers are in a neutral position in accordance with the disclosed architecture;

FIG. 2 illustrates a perspective view of one embodiment of the safety ladder device of the present invention wherein both outriggers are in an extended position in accordance with the disclosed architecture;

FIG. 3A illustrates a close-up view of one embodiment of the first outrigger of the safety ladder device of the present invention in accordance with the disclosed architecture;

FIG. 3B illustrates a close-up view of one embodiment of the second outrigger of the safety ladder device of the present invention in accordance with the disclosed architecture;

FIG. 4 illustrates a perspective view of one embodiment of the safety ladder device of the present invention comprising a plurality of safety straps and wherein both outriggers are in an extended position in accordance with the disclosed architecture;

FIG. 5A illustrates a close-up view of the right side of one embodiment of a safety strap of the safety ladder device of the present invention in accordance with the disclosed architecture; and

FIG. 5B illustrates a close-up view of the left side of one embodiment of a safety strap of the safety ladder device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from other embodiments may be combined.

As noted above, there is a long-felt need in the art for an improved ladder. There also exists a long-felt need in the art for an improved safety ladder device that provides more stabilization than existing ladders known in the art. In addition, there exists a long-felt need in the art for a safety ladder device that comprises safety mechanisms which prevent a user from falling off the device. Finally, there exists a long-felt felt need in the art for a safety ladder device that comprises safety mechanisms which prevent the death and serious injury of a user.

The present invention, in one exemplary embodiment, is comprised of a safety ladder device. The device is primarily comprised of a ladder frame, a plurality of ladder feet, a first outrigger, a second outrigger and at least one safety strap. The plurality of ladder feet and a foot of each outrigger may further be comprised of a continuous opening that can receive a ground spike or fastener, which allows a user to secure the device to and/or into a nearby surface for stabilization of the device during use. Both outriggers are also preferably secured to each side of the top step of the ladder frame via a hinge that allows both outriggers to move freely. Thus, the outriggers can be positioned in a variety of angles to further stabilize the device. In another embodiment, the outriggers may be of a fixed length or may be telescopic (i.e. adjustable length) to allow the outriggers to be positioned in a variety of orientations.

The device is further comprised of at least one (but preferably multiple) safety strap that is positioned around the ladder frame, such that it does not obstruct a user's ability to climb the device, but still prevents a user from falling backwards off the device. Each safety strap is further comprised of an end piece that has a first vertical sidewall, a second vertical sidewall, an outside wall, a hinge and a lock, wherein the end piece engages the front surface and rear surface of the ladder frame to inhibit forward and/or backward movement of the strap while the strap is attached to the frame. To further secure the strap to the ladder frame, a horizontal cross member is connected to either the first sidewall or the second sidewall via at least one hinge that allows the cross member to open, such that the end piece can be positioned around the front surface, rear surface and outside side surface of the ladder frame. Once positioned around the frame, the cross member can be closed via the hinge and locked via a lock that secures to the first or second sidewall. As a result, the strap becomes immovable and cannot fall off of or be removed from the device, even if a user falls and his or her weight contacts the strap.

As a result, the improved safety ladder device of the present invention is particularly advantageous as it provides a safer and more stable ladder-type device. The outriggers of the device also provide for stabilization of the device. Further, the safety strap prevents a user from falling off the device, while still allowing a user to use the device in an unobstructed manner. Therefore, both the outriggers and the safety strap serve as safety mechanisms to prevent the death and serious injury of a user while using a ladder-type device.

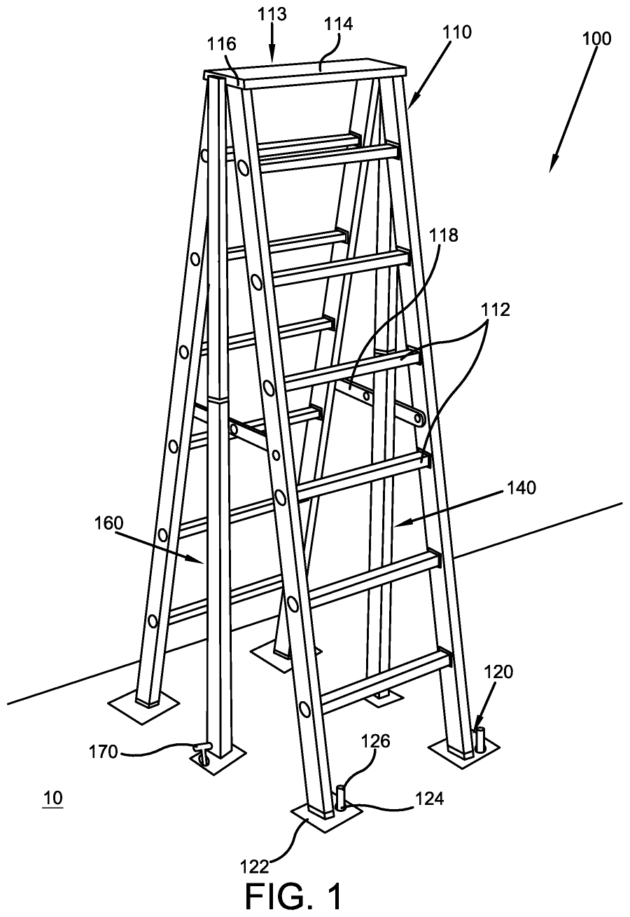

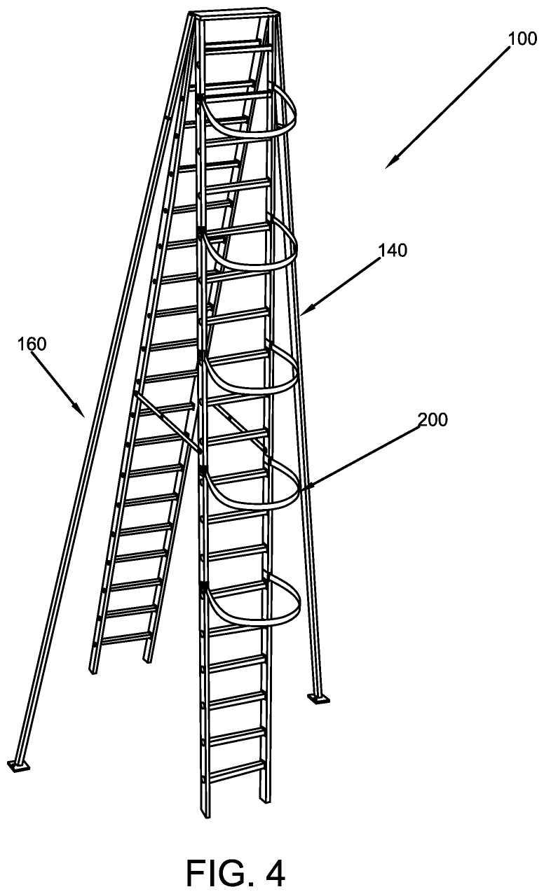

Referring initially to the drawings, FIG. 1 illustrates a perspective view of one embodiment of the safety ladder device 100 of the present invention wherein both outriggers 140, 160 are shown in a neutral position. The safety ladder device 100 is primarily comprised of a ladder frame 110, a plurality of ladder feet 120, a first outrigger 140, a second outrigger 160, and at least one safety strap 200 (as shown in FIG. 4). In the preferred embodiment, all components of the device 100 are comprised of a durable metal such as, but not limited to, stainless steel or aluminum, etc., or any other suitable material as is known in the art unless otherwise specified herein. The device 100 is comprised of a generally A-shaped frame 110 or other suitable shape, and has a plurality of fixedly or removably-secured steps or rungs 112, as well as two folding hinges 118 which allow the device 100 to be positioned in an open and closed position. In addition, the frame 110 has a plurality of feet 120, wherein each foot 120 has a flat bracket 122. In one embodiment, each bracket 122 may have a continuous opening 124 that can receive a ground spike 126 or other suitable fixating device as is known in the art. The ground spike 126 allows the device 100 to be anchored firmly into a ground surface 10. In addition, the continuous opening 124 may also receive a fastener 170, which allows the device 100 to be screwed, bolted, or fastened to a surface such as but not limited to: wood, metal, plastic, etc., or any other suitable surface as is known in the art. Therefore, the device 100 can also be secured to a plurality of nearby surfaces to ensure proper stabilization during use.

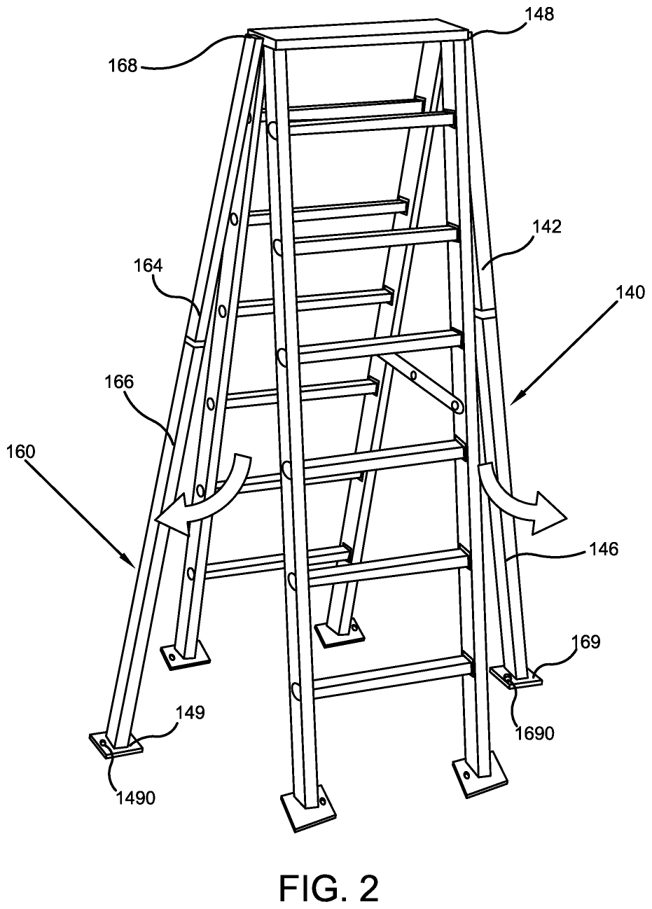

FIG. 2 illustrates a perspective view of one embodiment of the safety ladder device 100 of the present invention wherein both outriggers 140, 160 are shown in an angled or extended position. The top surface 114 and/or side surface 116 of any step or rung 112 (but preferably the top step 113) is comprised of a hinge 148, 168 or other articulating attachment point. The hinge 148, 168 may be any hinge known in the art, such as but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The hinge 148, 168 allows a first outrigger 140 to secure to one side of the frame 110. Similarly, the hinge 148, 168 allows a second outrigger 160 to secure to the opposing side of the frame 110 that is directly opposite the first outrigger 140. Both outriggers 140, 160 provide additional support and stability to the frame 110 when a user is using the device 100. It should be appreciated that the hinge 148, 168 that connects each outrigger 140, 160 to the frame 110 allows the outriggers 140, 160 to be positioned in a variety of angles in relation to the frame 110. For example, the outriggers 140, 160 can be positioned in a neutral, upright position as shown in FIG. 1. Further, each outrigger 140, 160 can be positioned in a more angled, extended position as shown in FIG. 2. It should be appreciated that the hinge 148, 168 allows an outrigger 140, 160 to be positioned at any suitable position within a 360-degree range of movement. In this manner, each outrigger 140, 160 can be secured to a floor surface, a wall surface, a ceiling surface or any other suitable surface as is known in the art, at any position or orientation.

Further, each outrigger 140, 160 may be comprised of a flat foot 149, 169 that has a continuous opening 1490, 1690 which can receive a ground spike 126 (as shown in FIG. 1) that allows each flat foot 149, 169 to be anchored firmly into a ground surface 10. In addition, the continuous opening 1490, 1690 may receive a fastener 170 (as shown in FIG. 1) which allows each foot 149, 169 to be screwed, bolted or fastened to a suitable surface, such as but not limited to: wood, metal, plastic, etc., or any other suitable surface as is known in the art. Therefore, the outriggers 140, 160 can be temporarily secured to a plurality of nearby surfaces to further ensure stability of the device 100. In one embodiment of the device 100, the feet 120 of the frame 110 and the feet 149, 169 of each outrigger 140, 160 are magnetic, such that the feet 120, 149, 169 can secure to a metal or other magnetic surface as is known in the art.

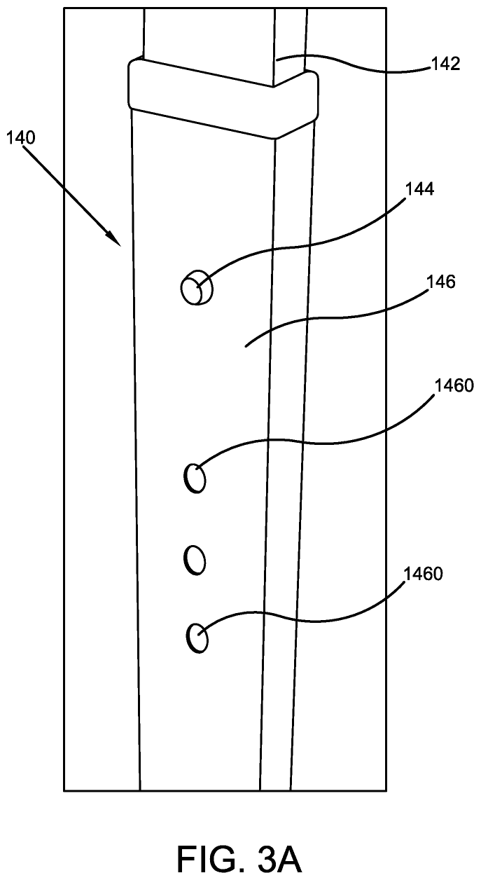

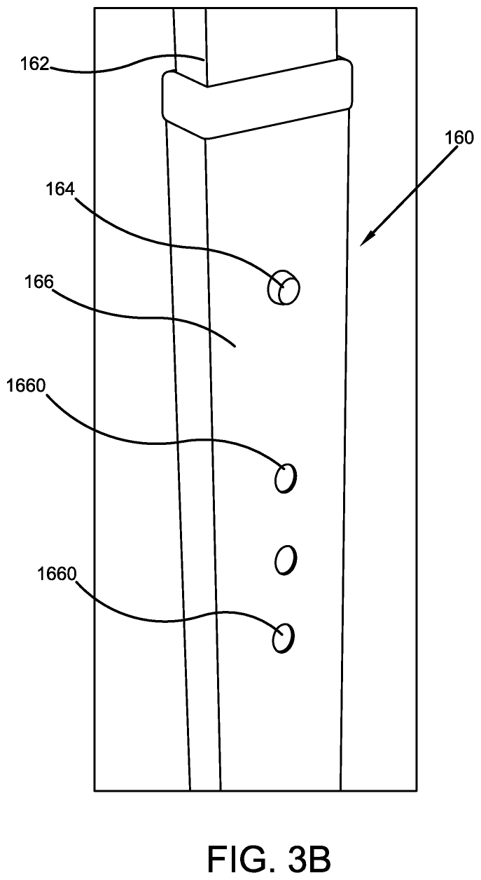

FIG. 3A and FIG. 3B each illustrate a close-up view of one embodiment of the two outriggers 140, 160 of the safety ladder device 100 of the present invention. In one embodiment, each outrigger 140, 160 may be of a fixed length. However, in an additional embodiment each outrigger 140, 160 may be telescopic, and therefore can vary in length depending on a user's wants and/or needs. To accomplish this, each outrigger 140, 160 is comprised of a first member 142, 162 and a second member 146, 166. The second member 146, 166 is further comprised of at least one continuous opening 1460, 1660. The first member 142, 162 is comprised of a spring-loaded protrusion 144, 164 that can be depressed when the first member 142, 162 is placed within the second member 146, 166. Then, once the first member 142, 162 is inserted far enough into the second member 146, 166 the protrusion 144, 164 engages the opening 1460, 1660, such that the first member 142, 162 is retained within the second member 146, 166 and cannot move. Once secured in place, a user can depress the protrusion 144, 164 such that it disengages the opening 1460, 1660 and releases the first member 142, 162, allowing the first member 142, 162 to be pulled outwards from the second member 146, 166. It is also contemplated that in one embodiment the device 100 comprises a plurality of continuous openings 1460, 1660, which allow the first member 142, 162 to be moved and locked (i.e. when the protrusion 144, 164 engages an opening 1460, 1660) within the second member 146, 166, which allows a user to adjust each outrigger 140, 160 to various lengths depending on where the device 100 needs to be positioned.

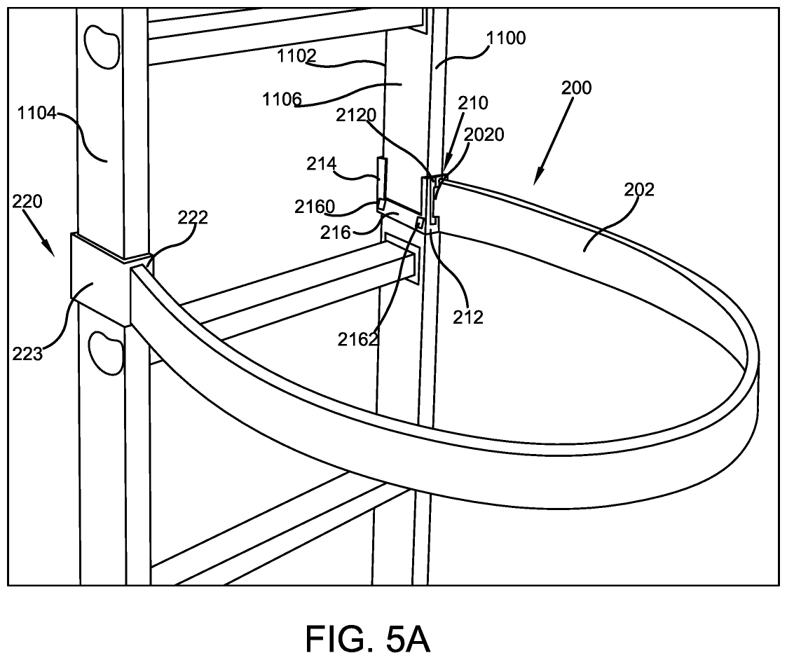

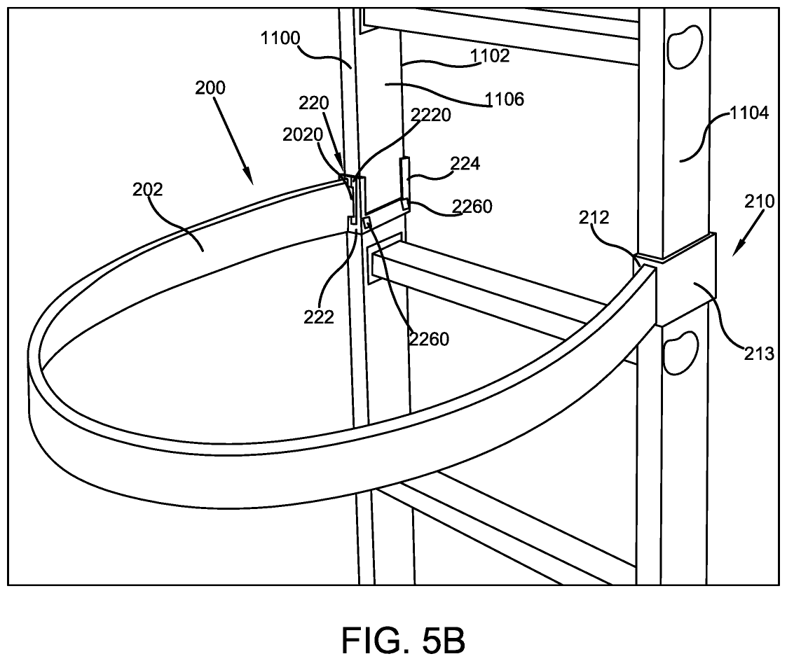

FIG. 4 illustrates a perspective view of one embodiment of the safety ladder device 100 of the present invention, wherein the safety ladder device 100 comprises a plurality of safety straps 200. To ensure that a user does not fall off the ladder device 100 during use, the ladder device 100 comprises at least one safety strap 200 that secures to the frame 110. In other embodiments, the body 202 of the strap 200 (shown in FIGS. 5A and 5B) may be semi-circular, semi-square, semi-triangular, semi-octagonal, etc., or any other suitable shape as is known in the art and is dimensioned to be slightly larger than the width and depth of a user. In this regard, the strap 200 does not obstruct a user's ability to climb the ladder device 100, but still prevents a user from falling backwards off the ladder device 100. In other embodiments, the strap 200 may be manufactured of a plurality of materials, such as but not limited to: rigid nylon or metal, or any other suitable rigid material as is known in the art. In addition, the strap 200 may be manufactured of a plastic such as but not limited to acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable plastic as is known in the art.

FIG. 5A and FIG. 5B. illustrate close-up views of the right and left sides of one embodiment of the safety strap 200 of the safety ladder device 100 of the present invention. Each strap 200 is comprised of an end piece 210, 220 that has a first vertical sidewall 212, 222, a second vertical sidewall 214, 224, an outside wall 213, 223, a hinge 2160, 2260 and a lock 2162, 2260. The first vertical sidewall 212, 222 and the second vertical sidewall 214, 224 of each end piece 210, 220 are connected by an outside wall 213, 223, and engage the front surface 1100 and rear surface 1102 of the frame 110 to inhibit forward and/or backward movement of the strap 200. The first vertical sidewall 212, 222 and the second vertical sidewall 214, 224 are further connected via a horizontal cross member 216, 226. The cross member 216, 226 is further fixedly-secured to either the first vertical sidewall 212, 222 or the second vertical sidewall 214, 224 via at least one hinge 2160, 2260. The hinge 2160, 2260 allows the cross member 216, 226 to open such that the first vertical sidewall 212, 222, the second vertical sidewall 214, 224 and the outside wall 213, 223 can be positioned around the front surface 1100, rear surface 1102, and outside side surface 1104 of the frame 110. Once positioned around the frame 110, the hinge 2160, 2260 allows the cross member 216, 226 to close across the inside side surface 1106 of the frame 110. A lock 2162, 2260 is further positioned on the first vertical sidewall 212, 222 or the second vertical sidewall 214, 224, opposite of the hinge 2160, 2260, which allows the cross member 216, 226 to be secured in a locked position around the frame 110. Therefore, the strap 200 becomes fixated to the frame 110 and will not fall off of the ladder device 100, even if a user falls and his or her weight contacts the strap 200.

In a preferred embodiment, the body 202 is fixedly-secured to each end piece 210, 220, and may be molded to each end piece 210, 220 during the manufacturing process. In an alternate embodiment, the body 202 may be removable from the first sidewall 212, 222, wherein the locking assembly 2162 remains in a locked position around the frame 110. In this manner, straps 200 that are obstructing an area of the device 100 or are unneeded can be removed, but also can be quickly reattached to the end piece 210, 220 which remains around the frame 110. It is contemplated that in this embodiment, the body 202 engages the first vertical sidewall 212, 222 of each end piece 210, 220 via a tongue 2020 that engages a groove 2120, 2220 located on each first sidewall 212, 222. In this manner, each tongue 2020 can be slid into each groove 2120, 2220, such that the body 202 is sufficiently secured to each end piece 210, 220 to prevent the body 202 from coming apart from each end piece 210, 220 in the event that a user falls on the body 202 of the strap 200. In another embodiment of the device 100, a kit is provided that comprises at least one outrigger 140, 160, at least one hinge 148, 168, and at least one strap 200 wherein the kit can be purchased by a user and retrofitted to any existing ladder device, or other suitable device as is known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “safety ladder device” and “device” are interchangeable and refer to the safety ladder device 100 of the present invention.

Notwithstanding the forgoing, the safety ladder device 100 of the present invention and its various components can be of any suitable size and configuration as is known in the art without affecting the overall concept of the invention, provided that they accomplish the above-stated objectives. One of ordinary skill in the art will appreciate that the size, configuration and material of the safety ladder device 100 as shown in FIGS. 1-5 is for illustrative purposes only, and that many other sizes and shapes of the safety ladder device 100 are well within the scope of the present disclosure. Although the dimensions of the safety ladder device 100 are important design parameters for user convenience, the safety ladder device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety ladder device comprising:
a ladder frame comprised of a plurality of ladder feet and a plurality of steps;
a first outrigger secured to the ladder frame;
a second outrigger secured to the ladder frame; and
at least one safety strap, wherein the first outrigger and the second outrigger stabilize the ladder frame, and further wherein the at least one safety strap does not obstruct a user's ability to climb the safety ladder device, but still prevents a user from falling off the safety ladder device.

2. The safety ladder device of claim 1, wherein the first outrigger and the second outrigger attach via a hinge to a top surface or side surface of any of the plurality of steps.

3. The safety ladder device of claim 2, wherein the hinge allows the first outrigger and the second outrigger to move within a three-hundred-and-sixty-degree range of movement.

4. The safety ladder device of claim 1, wherein the safety ladder device comprises a plurality of safety straps positioned at different intervals along a height of the safety ladder device.

5. A safety ladder device comprising:
a ladder frame comprised of a plurality of steps and a plurality of ladder feet, wherein each of the plurality of ladder feet are comprised of a continuous opening;
a first outrigger secured to the ladder frame and further comprised of a foot, wherein the foot is comprised of a continuous opening;
a second outrigger secured to the ladder frame and further comprised of a foot, wherein the foot is comprised of a continuous opening; and
at least one safety strap that secures to the ladder frame, wherein the first outrigger and the second outrigger stabilize the ladder frame, and further wherein the at least one safety strap does not obstruct a user's ability to climb the safety ladder device, but still prevents a user from falling off the safety ladder device.

6. The safety ladder device of claim 5, wherein a ground spike or a fastener is placed through the continuous opening of each of the plurality of ladder feet to anchor the ladder frame to a surface.

7. The safety ladder device of claim 5, wherein a ground spike or a fastener is placed through the continuous opening of the foot of the first outrigger and the foot of the second outrigger to anchor the ladder frame to a surface.

8. The safety ladder device of claim 5, wherein the plurality of ladder feet and the foot of the first outrigger and the foot of the second outrigger are magnetic.

9. A safety ladder device comprising:
a ladder frame comprised of a plurality of steps, a set of folding hinges, and a plurality of ladder feet, wherein each of the plurality of feet are comprised of a continuous opening;
a first outrigger that provides stability to the ladder frame and further comprises a foot with a continuous opening;
a second outrigger that provides stability to the ladder frame and further comprises a foot with a continuous opening; and
at least one safety strap that secures to the ladder frame and prevents a user from falling off of the safety ladder device, wherein the at least one safety strap comprises a set of end pieces each comprised of a first vertical sidewall, a second vertical sidewall, an outside wall, a horizontal cross member, a hinge and a lock.

10. The safety ladder device of claim 9, wherein the first outrigger and the second outrigger attach via a hinge to a top surface or side surface of any of the plurality of steps.

11. The safety ladder device of claim 10, wherein the hinge allows the first outrigger and the second outrigger to move within a three-hundred-and-sixty-degree range of movement.

12. The safety ladder device of claim 9, wherein the first outrigger and the second outrigger can be secured to a floor surface, a wall surface, or a ceiling surface via a ground spike or a fastener placed through the continuous opening of the foot of the first outrigger and the foot of the second outrigger.

13. The safety ladder device of claim 9, wherein the first outrigger and the second outrigger are of a fixed length.

14. The safety ladder device of claim 9, wherein the first outrigger and the second outrigger are telescopic and have an adjustable length.

15. The safety ladder device of claim 9, wherein a body of the safety strap connects to each of the end pieces.

16. The safety ladder device of claim 15, wherein each of the end pieces secures around the ladder frame.

17. The safety ladder device of claim 16, wherein the hinge allows the horizontal cross member to open to allow each of the end pieces to secure around the ladder frame.

18. The safety ladder device of claim 17, wherein once each of the end pieces are secured around the ladder frame, the lock can secure the horizontal cross member around the ladder frame to render the safety strap immovable.

19. The safety ladder device of claim 9, wherein the safety ladder device comprises a plurality of safety straps positioned at different intervals along a height of the safety ladder device.

20. The safety ladder device of claim 9, wherein a ground spike or a fastener is placed through the continuous opening of each of the plurality of ladder feet to anchor the ladder frame to a surface.
